(19) United States
(12) Patent Application Publication
(10) Pub. No.: US 2004/0027914 A1
(43) Pub. Date: Feb. 12, 2004

(54) Method and system for maintaining particles in suspension in a fluid

(76) Inventor: David R. Vrane, San Jose, CA (US)

Correspondence Address: BECTON, DICKINSON AND COMPANY, 1 BECTON DRIVE, FRANKLIN LAKES, NJ, 07417-1880, US

(21) Appl. No.: 10/216,481

(22) Filed: Aug. 8, 2002

(51) Int. Cl. B01F 9/10

(52) U.S. Cl. 366/213

(57) ABSTRACT

A system and method for maintaining a suspension of particles within a fluid are disclosed. A container holding a sample having particles and fluid is rotated about its axis at a first calculated rate for a first calculated time interval and then rotated about its axis at a second calculated rate for a second calculated time interval such that the sample flow effects that result maintain a suspension of particles within the fluid and agitate the sample. A cycle of rotation, including the first and second flow rates, may be repeated for a desired number of times for continuous maintenance of the particle suspension. A controller is programmed to rotate a motor connected to a container holder that rotatably drives the container about its axis. Sample may be aspirated from the container and transported to an analytical device while the container is being rotated. Because the rates of rotation of the cycle are relatively slow and because solid body rotation is not achieved during the cycle, the level of agitation that occurs results in only a negligible impact on the analytical device.

### TECHNICAL FIELD

The invention relates to maintaining particles in suspension in a fluid and allowing a suspension of particles to be continuously transferred to an operably associated analytical apparatus.

### BACKGROUND OF THE INVENTION

During flow cytometric sorting procedures, it is desired that cells or particles in a liquid sample remain suspended and evenly distributed within a fluid medium. Various agitation devices for shaking, rotating, and revolving containers to maintain particle suspensions within a fluid have been developed.

For instance, U.S. Pat. No. 5,439,645 to Saralegui et al. describes an apparatus, which employs a vortexer/mixer for orbitally mixing and resuspending a test tube's contents. The container contents are forced out of the container through an aspirating head probe after orbital rotation of a selected sample container has occurred.

U.S. Pat. No. 5,005,981 to Schulte et al. describes an apparatus for causing vortices in a test tube including an elongated member with an end for engaging a test tube and an end opposite thereto driven about an axis of the member for orbital movement with its axis. The apparatus further includes a gripping means for holding an open end of test tube during the movement and including an inflatable bladder, which upon inflation holds the open end of the test tube with a seal for closing the open end of the test tube.

However, with regard to such devices, agitation of the sample is stopped before a sample flow stream is withdrawn from the container. Therefore, continuous suspension of particles within a fluid sample and agitation is not maintained. Thus, streams of cells withdrawn from the container may not contain an accurate representation of the cells present within the sample resulting in erroneous analytical results.

Also with regard to the prior art, where sample agitation is not stopped during sample aspiration, alignment problems associated with the analytical device used would typically result. This is because the shaking motions are of sufficient strength and direction so as to cause misalignment of elements of the analytical device. Realignment and recalibration of the device is necessitated in order to achieve reliable sample analytical results, and, this may include stopping the agitation. Further, violent shaking motions may cause damage to the particles to be analyzed.

U.S. Pat. No. 6,235,537 to North et al. describes an apparatus and a method for washing cells incorporating a method of resuspending the cells. The method and apparatus describe a test tube, containing cells to be washed, and a rotatable spindle inserted into the open top of the test tube. In the method, the test tube is first spun about its vertical axis by a drive motor to drive by centrifugal force the larger, more dense cells against the inner wall of the test tube. A washing fluid is delivered to the bottom of the test tube displacing fluid containing smaller, less dense cells, debris, and unbound agents through passageways in the spindle. This is drawn to an external reservoir. Wash fluid thus displaces and removes the unwanted supernatant. After the cells are adequately washed, the wash fluid flow is stopped and the drive motor is rapidly stopped by braking. The rapid stopping of the test tube rotation causes the fluid inside the test tube to continue rotating, which washes over the cells at the test tube inner wall, resuspending some cells. The test tube may be rotated and stopped several times to increase cell recoveries.

With this method and apparatus, cells are washed by a method including application of a centrifugal force pushing the larger cells to the sidewalls and removing the smaller cells. After washing, the larger remaining cells are resuspended through rapid stopping and restarting of the drive motor. Surfactants in the wash solution assist in the resupension of cells showing that the rotational method of the patent alone may not be sufficient to resuspend the cells. Further, the patent fails to describe a method for continuously maintaining a suspension of cells. In addition the very rapid braking required to scour pelleted cells from the tube wall is likely to damage the cells.

Therefore, it is an object of the present invention to provide a system and method for maintaining a suspension of particles in a fluid.

It is another object of the present invention to provide a system and method for maintaining a suspension of particles in a fluid without damaging the particles.

It is another object of the present invention to provide a system and method for maintaining a suspension of particles in a fluid while simultaneously withdrawing said sample for cytometric analysis.

### SUMMARY OF THE INVENTION

These and other objects are achieved by a system and method for rotating a container holding a sample, including particles suspended in a fluid, at a first rate for a defined time and a second rate, higher or lower than the first rate, for a defined time such that sample flow effects that result from alternating between the rotational rates maintain a suspension of particles within the fluid and agitate the sample. It is known in the prior art that an impulsive change in angular velocity of a fluid by a small amount held in a container rotated about its axis results in transient secondary flow effects. However, it is not known in the prior art that the secondary flow effects can be utilized to maintain a suspension of particles. The suspension of particles, in the present invention, may be continuously maintained by repeating a cycle of rotation described above.

The rotating container may be in fluid communication with an analytical device through a withdrawing device, such as an aspiration tube. Sample may be aspirated from the container and transported to the analytical device, such as a cytometer, while the container is being rotated. Because the rates of rotation are relatively slow and because alternating between the rates of rotation prevents solid body rotation, which would impart centrifugal forces on the sample, the level of agitation that occurs does not transfer a significant amount of vibration to the cytometer. In other words, components of the cytometer, such as a laser, detector, and droplet generation mechanism do not require re-aligning or other type of reconfiguration due to the vibration from sample agitation in order for reliable sample analysis to occur. Thus, streams of cells withdrawn from the container will contain an accurate representation of the cells present within the sample resulting in reliable analytical results. Also, because minimal centrifugal forces are imparted on the particles during the cycle of rotation, it is less likely that the particles will be damaged, or stratified in any way. This allows cells to be subsequently recovered after a sorting procedure and used for kinetic studies, cell culture, or other processes.

In the invention, the container holding the sample is rotated at a first calculated rate for a first calculated time interval about its longitudinal axis. The first rate and time interval are such that solid body rotation of the sample does not result. The particles are maintained suspended within the fluid and do not migrate to the container walls as a result of centrifugal forces. In one example, the time interval of the first rate of rotation is of a length where solid body rotation is on the threshold of occurring but does not, because the first rate of rotation is changed before it does occur. The second altered rate of rotation for the second calculated time interval results in a transient secondary flow of the sample producing transient motions that keep the particles suspended within the fluid and that thus agitate the sample. The cycle of rotation, including alternating between the first and second rates, may be repeated to continuously maintain the suspension of particles within the sample. Where the second rate is changed to the first rate, transient secondary flow also occurs but in the opposite direction.

A controller, motor, and container holder are included within the system of the invention. The controller is programmed to rotate the motor connected to the container holder. The container holder rotatably drives the container about its axis at the first and second calculated rates for the first and second time intervals for a desired number of cycles. The invention is advantageous in that particle settling on a bottom surface of the container is avoided because particles are continuously maintained in suspension during said cycles.

### BRIEF DESCRIPTION OF THE DRAWINGS

FIG. 1 is a plan view of the system of the present invention connected to an analytical apparatus.

FIG. 2 is a block diagram of a sample withdrawn from the system of FIG. 1 and a block diagram of the analytical apparatus of FIG. 1.

FIG. 3A is a perspective view of an alternative embodiment of the present invention shown in FIG. 1.

FIG. 3B is a partial view of the embodiment of the present invention shown in FIG. 3A.

FIG. 4 is a cross-sectional plan view of a container used in conjunction with the system of FIG. 1 showing a representation of the transient secondary flow that occurs during the method of the present invention.

FIG. 5 is a graphical representation of n-multiple curves of settling velocity as a function of steady-state angular velocity and impulse magnitude.

FIG. 6 is a graphical representation of depth-normalized characteristic time scale as a function of steady-state angular velocity.

### BEST MODE OF THE INVENTION

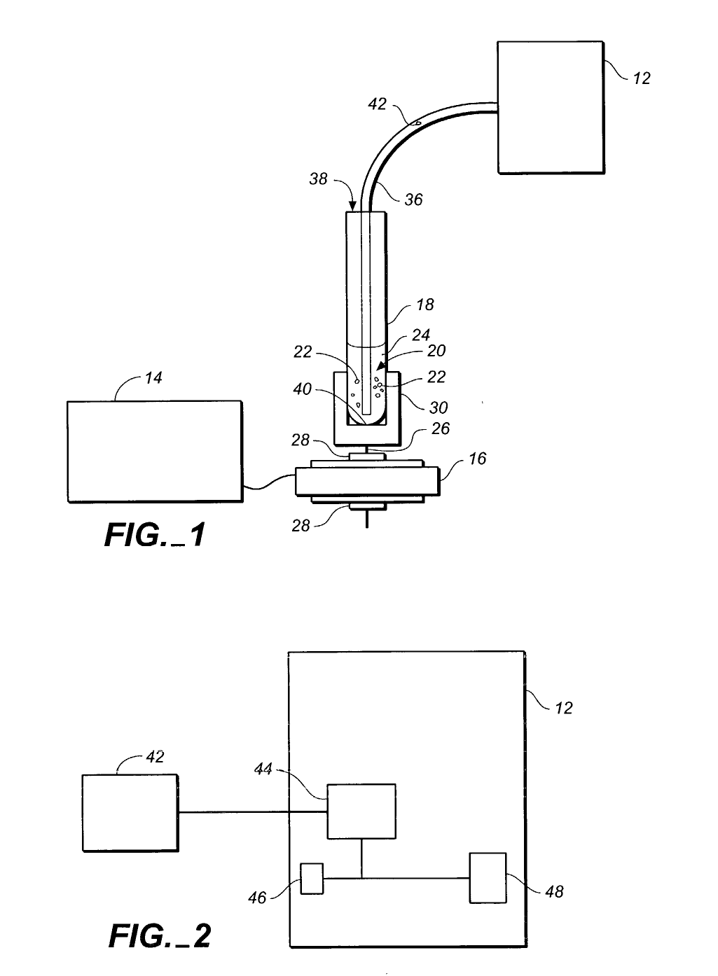

Referring to FIG. 1 there is seen a system of the present invention connected to an analytical device 12 of a type known in the art. Device 12 may be a flow cytometer, blood analyzer, or any other analytical system that analyzes particles in liquid. The system includes a motor controller 14 including controller circuitry (not shown) programmed to rotate a motor 16 driving a container 18 containing a sample 20 including particles 22 and fluid 24, such that a sample agitation is achieved through a desired cycle of rotation of the container 18 about a longitudinal container axis z (see FIG. 4). In one example, the container 18 is a test tube. The container may be any axisymmetric container. The controller 14 is programmed to rotate the motor 16 at a first rate for a first interval of time and to rotate the motor 16 at a second rate, either higher or lower than the first rate, for a second interval of time. Alternating between the first and second rates of rotation results in sample flow effects that maintain a suspension of particles 22 within the fluid 24 and agitate the sample 20. The cycle of rotation, including the first and second rates for the first and second time intervals, may be repeated a desired number of times for continuous maintenance of particle suspension. The rates of rotation and time intervals of each rotation rate are calculated based upon the formulas that will be discussed below.

The motor 16, for example a stepper motor, rotates and imparts rotation to the container 18 upon receipt of instructions from the motor controller 14. A shaft 26 passes through an opening of the motor 16 and may be secured to the motor 16 through bearings 28. The shaft 26 is also secured to a container holder 30 at one end. The container 18 is securely mounted onto the container holder 30.

Upon instructions from the controller 14, power is provided to the motor 16 and the motor 16 rotates at the first rate for the first time interval. As the motor 16 rotates the shaft 26 to which the motor is connected, the container holder 30 to which the shaft 26 is connected, and the container 18 which is mounted within the holder 30 also rotate. Thus, the motor 16 is drivingly coupled to the container holder 30 and container 18 through the shaft 26. The container 18, and container holder 30 driven by motor 16 rotate about longitudinal axis z of the container seen in FIG. 4. Upon further instructions from the motor controller 14, the motor 16, shaft 26, container holder 30 and container 18 rotate about the longitudinal axis z for the second rotation rate at the second time interval. As the container is rotated at alternating rates, the fluid 24 present within the container exhibits transient vertical flow effects, maintaining suspension of the particles 22 within the fluid 24 and agitation of the sample 20 as will be described below.

Referring to FIGS. 1 and 2, in another embodiment, the system of the present invention includes a sample aspiration device 36 connected to the system of the present invention. The system of the present invention may be a component of the analytical device 12. The sample aspiration device 36 is for example, an aspiration probe and the analytical device 12 is for example, a cytometric device such as a sorting flow cytometer or a flow cytometer. In one example, the aspiration probe 36 is inserted within an opening 38 of the container 18. One end of the aspiration probe 36 is in contact with the sample 20 and extends proximate to a bottom surface 40 of the container 18. The other end of the aspiration probe is connected to the analytical device 12. A stream of suspended particles 42 may be withdrawn or aspirated from the container 18 and transferred to the analytical device 12 for analysis. In FIG. 2, the analytical device 12 is seen to include a flow cell or droplet generator 44, light source 46, and detector 48 as well as other elements (not shown) for analysis of droplets generated from the stream of suspended particles 42 of FIG. 1.

In the present invention, sample may be withdrawn from the container 18 and transferred to the cytometric device 12 while the container 18 including sample 20 within the container is being rotated. Because the rates of rotation about the axis z are relatively slow and alternate between rates, solid body rotation is not achieved or is prevented from occurring. Therefore, the method is advantageous in that particles 22 are less likely to become damaged during agitation while remaining suspended within the fluid 24 during the cycle of rotation. The cells do not “pellet” or form a layer on the container wall, and do not have to be subsequently scoured from the wall. This more gentle treatment of cells preserves cell viability. In addition, analysis of the cells is less prone to artifacts from cell damage. Further, the level of sample agitation that occurs, results in only a negligible impact on the cytometer 12. A negligible impact means that components of the cytometer 12, such as the droplet generator 44, the illumination source 46, and detector 48 will not require re-aligning or some other type of reconfiguration due to the effects of sample agitation in order for reliable sample analysis to occur.

When the controller 14 alternates rotation rates of the motor 16 between the first and second rates for the first and second time intervals, a change in angular velocity of the fluid occurs. The change may be described as sudden and incremental. During the velocity change, transient secondary flow occurs during which the fluid 24 adjusts to the new rotational speed. The secondary fluid flow that occurs during the second rotation rate, after the first changing of rates has occurred and during the first rate, after the second changing of rates has occurred allows for continuous suspension of particles 22 within the fluid 24 and agitation of the sample 20 at a relatively low rate of rotation. The first and second rates of rotation alternate in consecutive calculated time intervals.

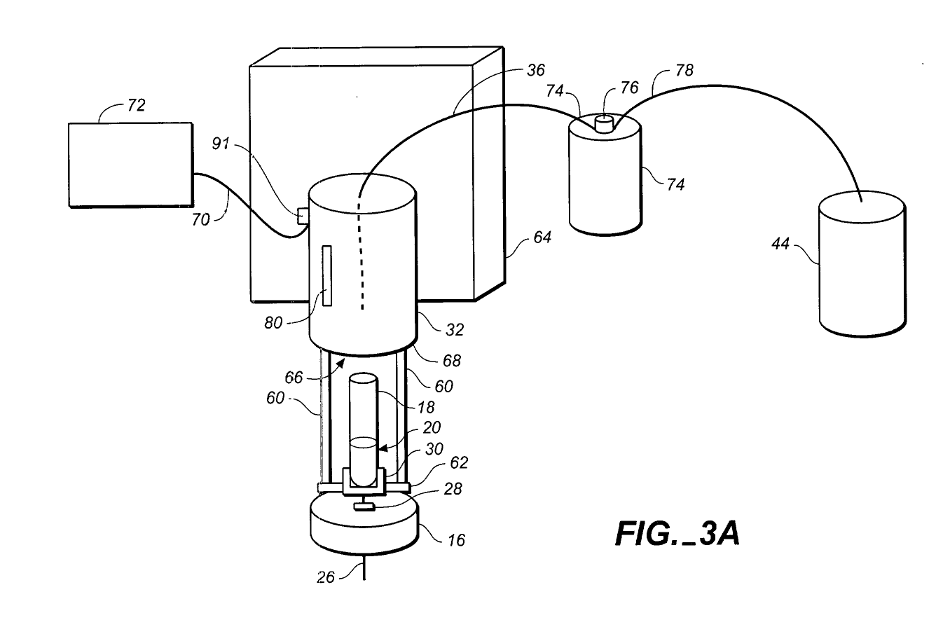

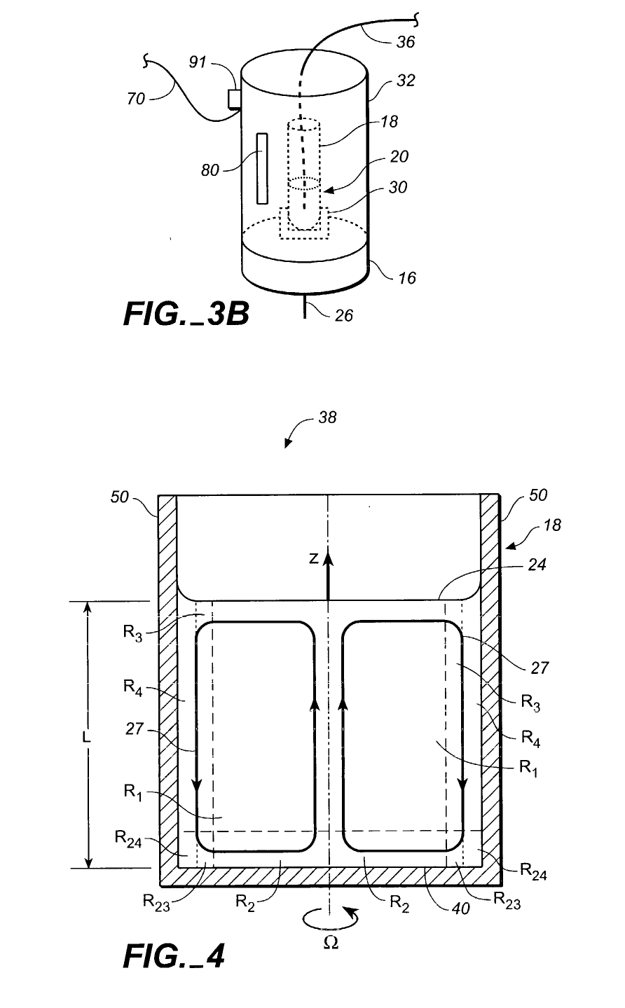

With reference to FIGS. 3A and 3B, another embodiment of the invention including a pressurized housing 32 is seen. The motor 16, container holder 30 and container 18 of the present invention are moveable relative to the housing 32 through bars 60 attached to a lift platform 62. Each bar 60, for example a piston rod, is attached to the lift platform 62 at an end nearest the motor 16 and rides within a cylinder (such as pneumatic or hydraulic cylinder not shown) at another end. The cylinders are disposed within a bar housing 64 disposed outside of the pressurized housing 32. The platform 62 is mounted to the motor, which is connected to the container holder 30 housing the container 18, as described above. The platform 62 may be moved relative to the housing 32. When the bars 60, thus lift platform 62 and connected motor 16, container holder 30 and container 18, are lowered through the cylinders, the pressurized housing 32 will no longer be pressurized as air will be able to flow out. Conversely, when the bars 60 are raised through the cylinders, a bottom opening 66 of the housing 32 is closed so that the housing 32 may be pressurized and the aspiration probe 36 may be inserted within container 18. When the housing 32 is pressurized, sample is pushed (by pressure) into the aspiration probe 36 inserted into the container 18. A bottom surface of the pressurized housing may rest upon a surface of the motor 16 or alternatively, the motor 16 is of a shape corresponding to the opening 68 of the pressurized housing 32 so that the motor 16 is able to plug up the opening 68 (FIG. 3B). Air is supplied to the housing through air tube 70 connected to air supply 72 so that the housing 32 becomes pressurized. The housing 32 may include a pressure transducer 91 linked to the air tube 70 to control and vary the pressure within the housing 32. The pressurized housing 32 allows sample 20 to be aspirated from the container 18 through the aspiration probe 36. The aspiration probe then provides sample to the analytical system 12 (FIGS. 1 and 2).

Still referring to FIGS. 3A and 3B the aspiration probe 36 is connected at one end to a manifold 74. The sample is pushed into the manifold 74 through probe 36 and pushed out of the manifold through tube 78. The manifold may be connected to other tubes (not shown) supplying and transferring other types of solution to and from the manifold 74. The manifold includes a valve 76, for example a stream selector valve, which activates the passage of the solution from the manifold to the flow cell 44 of the analytical device 12. Specifically, when tube 78 is activated with the valve 76, sample 20 will be delivered to the flow cell 44 through tube 78. The stream selector valve 76 may also be placed in an off position so that no solution will be delivered.

In one embodiment, the housing 32 may include a window 80 so that a user may observe the amount of sample that is present within the container 18.

With reference to FIG. 4, it is seen that during secondary flow, the fluid sample 24 may be considered in the present model to act as separated into a core region R₁ and several boundary layer regions R₂, R₃, R₄, R₂₃ and R₂₄. Recirculating flow 27 occurs within the container upon a cycle of rotation of the present invention. Recirculating flow 27 occurs adjacent to wall 50 of container 18 in the boundary layer regions. Thus, recirculating flow 27 is disposed between the core region R₁ and the wall 50 of the container 18. The recirculating flow direction is reversible upon changing the second rate of rotation to the first rate of rotation.

In the present invention, it is desired that the vertical velocity of the core R₁ is larger than Stokes settling velocity of the particle within the fluid. Where the vertical velocity of the core is larger than Stokes settling velocity during both rates of rotation, the particles 22 will remain suspended within the fluid 24 and thus particles are prevented from settling. In one example, no particles will settle on the bottom interior surface 40 of the container 18. The core R₁ vertical velocity u_{z}, is calculated by Equation 1 as follows:

$${u}_{z} = ϵ \sqrt{Ω v} \frac{Z}{L} {ⅇ}^{- t / T} \qquad ( Eq . 1 )$$

where ε is a fraction change of rotational speed also called impulse magnitude, Z is the length variable along the axis of the container, L is the depth of the fluid in the container, e^{x} is the exponential function, T is the time constant, and t is the real time. The Stokes settling velocity of a spherical particle, uₛ, is calculated by Equation 2 as follows:

$${u}_{s} = \frac{Δ {pgd}^{2}}{18 pv} \qquad ( Eq . 2 )$$

where Δp is the density difference between the particle and the ambient fluid, g is the gravitational acceleration, d is the diameter of a particle in the sample, p is the ambient fluid density and v is kinematic viscosity of the fluid.

Equations 1 and 2 can be used to calculate the first and second rates of rotation of the container 18 to obtain a desired degree of agitation velocity of the fluid 24. The angular velocity in radians per second may be converted to other desired units.

In accord with the present invention, the second rate of rotation is different from the first rate of rotation. Therefore, where the second rate of rotation is less than the first rate of rotation, the second angular velocity of the container 18 is less than the first angular velocity/rate of rotation of the container. Where the second rate of rotation is greater than the first rate of rotation, the second angular velocity of the container is greater than the first angular velocity/rate of rotation of the container.

The norm of the Equation 1, (the core R₁ vertical velocity) is ε\sqrt{Ωv}. Equating an arbitrary multiple n of the norm to the settling velocity allows one to solve for angular velocity and arrive at Equation 3 for angular velocity Ω. The first rate or second rate of rotation may be calculated by Equation 3 as follows:

$$Ω = {\frac{1}{{v}^{3}} [ \frac{n Δ {pgd}^{2}}{18 p ϵ} ]}^{2} \qquad ( Eq . 3 )$$

where Ω is a steady-state angular velocity of the container, v is kinematic viscosity of the fluid, p is the density of the ambient fluid, g is the gravitational acceleration, d is the diameter of a particle in the sample, Δp is the density difference between the particle and the ambient fluid and ε is a fraction change of rotational speed also called impulse magnitude.

If the first rate of rotation is solved for using the equation, the second rate of rotation may be calculated based upon the calculated value of the first rate and the value of ε, the impulse magnitude. Specifically, the value of ε converted into desired units, is added to or subtracted from the calculated value of Ω for the first rate derived from Equation 3, to result in the second rate of rotation. The time interval for the first or second rates may be calculated by Equation 4 as follows:

$$T = \frac{L}{\sqrt{{Ω}_{v}}} \qquad ( Eq . 4 )$$

where T is the time interval, L is the depth of fluid, Ω is the fixed angular velocity of the fluid and v is the kinematic viscosity of the fluid.

The first time and second time intervals, or the amount of time for which the container is rotated at the first and second rate, may be calculated by inserting the value of Ω for the corresponding first rate or second rate into Equation 4 with other required parameters. After the sample has been rotated at the first rate for the calculated time interval, rotation switches to the second rate for the second interval.

The change to the second rate results in the transient secondary flow described above that agitates the sample. A change from the second rate to the first rate would also result in vertical transient flow, but in the opposite direction (see FIG. 4). A cycle of alternating between the first and second rates maintains suspension of particles and may be repeated for continuous suspension of particles. For both the first and second rates of rotation the sample is rotated at rates and times that result in a core R₁ vertical velocity that is greater than the settling velocity.

It is not necessary that the direction for both of the rates of rotation be the same. For instance, where the rate of rotation alternates between a first rate and a second rate of rotation of 0 RPM, the direction the first rate of rotation assumes after the second time interval may be the same or opposite direction that occurred during the second time interval. Where the second rate of rotation is 0 RPM the cycle of rotation involves starting and stopping the rotation of the container. The rates of rotation may vary from 0 RPM to greater than 0 RPM.

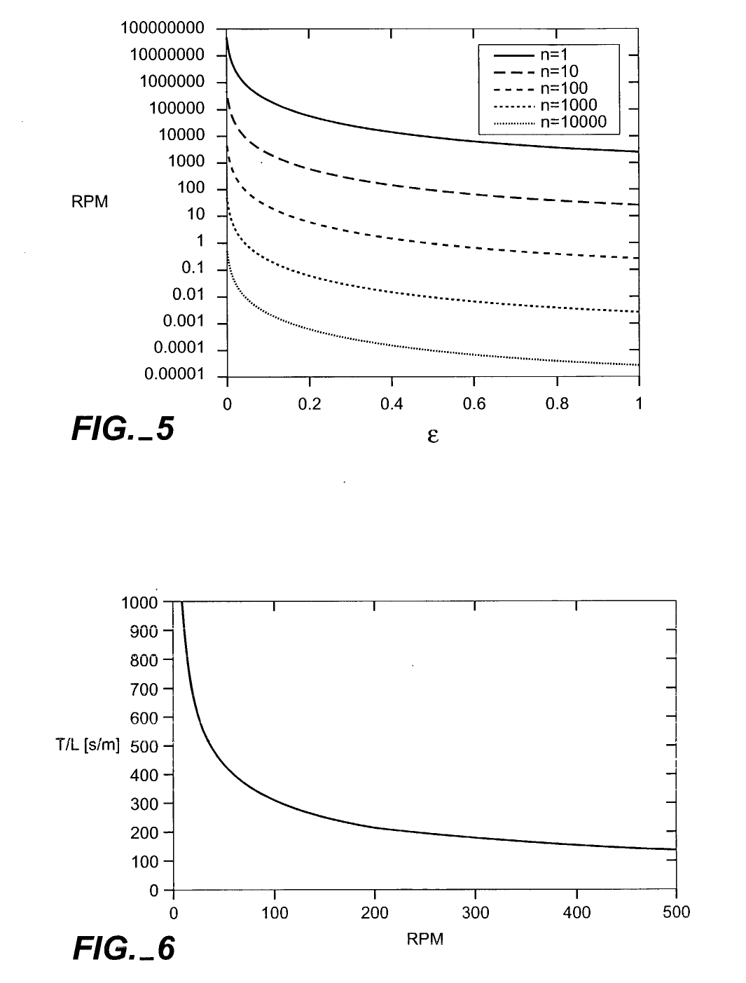

With Equation 3, a graphical illustration as shown in FIG. 5 may be generated and with Equation 4, a graphical illustration as shown in FIG. 6 may be generated for each particular sample. The graphical representations may be used to interpolate desired first and second rates of rotation and corresponding time intervals. For example, in a sample rotating in a container at 100 RPM and having a fluid density of 1030 kg/m³, a cell density of 1060 kg/m³, and a nominal value for cell diameter of 10 μm, a second rate of angular velocity Ω can be calculated as follows. The acceleration due to gravity g, is 9.81 m/s², viscosity v of the fluid is 10.05×10⁻⁷ m²/s, and Δp is calculated to be 30 kg/m³. Substitution of these values into Equation 3 and conversion of angular velocity to RPM results in Equation 5 for rotational speed versus a fraction change ε in the rotational speed represented as follows:

$${Ω}_{RPM} = 2.36 \times {10}^{- 5} {( \frac{n}{ϵ} )}^{2} \qquad ( Eq . 5 )$$

Equation 5 is depicted in FIG. 5 in graphical form where n multiple curves of settling velocity are shown as a function of RPM and fraction change of rotational speed ε. With reference to FIG. 5, the second rate of rotation can be determined for this particular sample. The corresponding fraction change in rotational speed ε may be interpolated or determined from the graph. To ensure, for example, that the vertical velocity (Eq. 1) is at least 1000 times greater than that of settling velocity when the container is rotating at 100 RPM, FIG. 5 indicates that the fraction change in rotational speed ε must be greater than or equal to a fraction change of approximately 0.155 or 16% when rounded up. Thus, a 16 RPM shift in angular velocity will provide the required agitation to achieve the desired secondary flow and to ensure that the vertical velocity is at least 1000 times greater than the settling velocity. The shift may involve either a decrease of 16 RPM resulting in a second angular velocity of 84 RPM or an increase of 16 RPM resulting in a second angular velocity of 116 RPM.

FIG. 6 indicates that where the container holding the sample described above is rotating at 100 RPM and where the fluid of the sample has a depth of 2.5 cm in the container, a first time interval of approximately 7.63 seconds may be calculated as follows. A transient time of approximately 305 sec/m×0.025 m=7.63 seconds. Where the container holding the sample is rotating at 116 RPM and where the fluid of the sample has a depth of 2.5 cm, a second time interval of approximately 7.5 seconds may be calculated as follows. A transient time of approximately 300 sec/m×0.025 m=7.5 seconds. Therefore, the first rate of rotation for this particular sample may be 100 RPM for a first time interval of 7.63 seconds and the second rate of rotation may be 116 RPM for a second time interval of 7.5 seconds if the angular velocity is to be 1000 times greater than the settling velocity for this particular sample.

The vertical velocity need not be at least 1000 times the settling velocity. However, it is desired that the first rate of rotation be sufficient such that n is greater than or equal to 1 so that the particles remain suspended in the fluid and do not settle. Therefore, the time interval and the RPM may be rounded up or down to a value, or alternatively be a different value so long as solid body rotation or settling of the particles on the bottom surface is not caused. Accordingly, many values for rates of rotation and time intervals may be used to maintain suspension of the particles. The cycle of rotation may be repeated as desired to maintain continuous suspension of particles and to prevent any particles from settling.

Initially, the particles within the sample of the container may have settled out before the rotation cycle of the present invention begins or may be in solid body rotation. If the sample has settled out, the cycle of rotation of the present invention will first disperse particles as long as n is greater than or equal to 1. The greater the value of n, the quicker the particles will disperse.

In calculation using the stated equations (Equations 3 and 4), depth L of sample fluid in the container, may be said to be fixed between sample runs to allow for ease in calculation. In reality, depth L decreases slightly as sample is aspirated from the sample tube. However, this flow entails a very small volume. The equations of the invention allow for exact calculation but the system of the present invention may have default numbers that work well for many various samples at many various fluid levels.

In the present invention, the equations neglect the presence of a deformable free fluid surface. The presence of a deformable free fluid surface can be neglected as it is assumed that the container RPM will remain relatively low. Because the container RPM will remain relatively low, the upper interface shape of the fluid of the sample will change negligibly from one rotational state to the next. Equation 6 is used to calculate the Froude number inequality which justifies neglecting the presence of a free deformable surface as follows:

$$Fr = \frac{{Ω}^{2} {d}^{2}}{gL} \leq 1 \qquad ( Eq . 6 )$$

where g is gravity, Ω is angular velocity, d is diameter and L is depth of fluid. For a container having a diameter of 12 mm, filled with 25 mm of fluid and rotating at 100 RPM, the Froude number is calculated to be 0.07. For small Froude numbers, in the range of 0≦1 in this example, the amount of rotational kinetic energy that can be applied toward deforming the free surface is small compared to gravity, therefore the free surface of the fluid of the sample remains unchanged from its resting state.

Also, the presence of the stationary aspiration tube in the container results in further sample agitation. Due to the presence of the tube, the fluid within the container cannot reach solid body rotation as a consequence of a no-slip condition on the container inner surface. Instead, the transient secondary flow gives way to a stable Couette flow far from the container bottom. Close to the container bottom there exists a steady-state component of centrifugal pumping as the Couette velocity distribution in the core R₁ does not match the transient flow or near solid body rotation of the fluid particles at the container bottom. Therefore, besides allowing for transfer of sample from the container to the analytical device the aspiration device is also advantageous in that it provides for further agitation.

What is claimed is:

1. A method of maintaining suspension of particles in a fluid, the method comprising:
a) placing a sample, including particles suspended in said fluid, in a container having a bottom interior surface;
b) rotating said container about an axis of said container at a first rotational rate for a first time interval;
c) rotating said container about said axis at a second rotational rate, different from said first rate, for a second time interval;
d) repeating steps b) and c) for a desired number of cycles wherein particle settling on said bottom container surface is avoided while continuously maintaining particles in suspension during said cycle.

2. The method of claim 1 wherein said first and second rotational rates and first and second time intervals are such that solid body rotation of said sample is prevented from occurring.

3. The method of claim 1 wherein said second rotational rate is less than said first rotational rate.

4. The method of claim 1 wherein said second rotational rate is greater than said first rotational rate.

5. The method of claim 1 wherein said second rotational rate is 0 revolutions per minute.

6. The method of claim 1 wherein said first and second rotation rates are calculated based upon density difference between said particles and said fluid, viscosity of said fluid, and depth of said fluid.

7. The method of claim 1 wherein said first and second time intervals are calculated based upon viscosity of said fluid, depth of said fluid and one of said first or second rotation rate.

8. The method of claim 1 further comprising transferring a flow stream of said sample from said container to an analytical device during said cycle.

9. The method of claim 8 wherein said first and second rates of rotation are of a value resulting in a level of agitation that has a negligible impact on said analytical device when in fluid communication with said container.

10. The method of claim 1 wherein said container rotates in a single rotational direction for said first and second rate of rotations.

11. The method of claim 1 wherein said container rotates in a first direction during said first rate of rotation and a second direction during said second rate of rotation.

12. A method of maintaining suspension of particles in a fluid comprising:
rotating a container having a bottom interior surface and containing a sample, including fluid and particles suspended in said fluid, about an axis of said container at a first rate for a calculated amount of time such that a first vertical velocity of said fluid is achieved, but where solid body rotation of said fluid is avoided; and
changing said first rate of container rotation to a second different rate of rotation for a calculated time interval such that a second vertical velocity of fluid resulting in transient secondary flow of said fluid is achieved during said interval, wherein particle settling on said container surface is avoided and agitation of said sample occurs during said container rotation, thereby mixing particles in said sample.

13. The method of claim 12 further comprising alternating between said first rate of rotation and said second rate of rotation.

14. The method of claim 12 wherein said second rate of rotation is less than said first rate of rotation.

15. The method of claim 12 wherein said second rate of rotation is greater than said first rate.

16. The method of claim 12 wherein said second rate of rotation is 0 revolutions per minute.

17. The method of claim 12 further comprising alternating between said first and second angular velocities.

18. The method of claim 12 wherein said transient secondary flow produces a boundary layer of fluid sample, a vertical core flow of fluid sample, and a recirculating flow adjacent to container walls in said boundary layer of said fluid sample.

19. The method of claim 18 wherein said second angular velocity produces a vertical velocity of said core of said sample that is greater than Stokes settling velocity.

20. The method of claim 12 further comprising transferring a flow stream of said sample from said container to an analytical device during said agitation.

21. The method of claim 21 wherein said first and second angular velocities are of a value resulting in a level of agitation that has a negligible impact on said analytical device when in fluid communication with said container.

22. A system for agitating a container having a bottom interior surface to maintain suspension of particles in a fluid contained within said container, the system comprising:
a container holder onto which said container is mounted;
a motor drivingly coupled to said container holder wherein said container holder is rotatably driven by said motor about an axis of said container; and
a motor controller programmed to a) rotate said container about an axis of said container at a first rotational rate for a first time interval, b) to rotate said container about said axis at a second rotational rate, different from said first rate, for a second time interval, and c) to repeat steps b) and c) for a desired number of cycles wherein particle settling on said container surface is avoided while continuously maintaining particles in suspension during said cycle.

23. The system of claim 22 wherein said system is a component of an analytical device.

24. The system of claim 22 further comprising a sample withdrawing device connected to said analytical device and disposed within said container wherein fluid may be withdrawn by said withdrawing device for analysis by said analytical device.

25. The system of claim 24 wherein said withdrawing device is an aspiration probe.

26. The system of claim 23 wherein said analytical device is a flow cytometer.

27. The system of claim 23 wherein said analytical device is a sorting flow cytometer.

28. The system of claim 22 further comprising a pressurized housing surrounding said container holder.
